(19) United States
(12) Patent Application Publication
(10) Pub. No.: US 2012/0305654 A1
(43) Pub. Date: Dec. 6, 2012

(54) SMARTCARD WITH REGENERATED ELECTRIC POWER

(75) Inventors: Lian WANG, Taipei (TW); Tar Li HSIEH, Yangmei City (TW)

(73) Assignee: ULTRACAP TECHNOLOGIES CORP., Hsinchu (TW)

(21) Appl. No.: 13/480,148

(22) Filed: May 24, 2012

(30) Foreign Application Priority Data
Jun. 1, 2011 (TW) 100119131

(51) Int. Cl. G06K 19/073

(52) U.S. Cl. 235/492

(57) ABSTRACT

The present invention relates to a smartcard, comprising: an energy converting device for converting energy into electric power; a power storage component for storing the electric power supplied by the energy converting device and outputting a voltage; and a voltage stabilizing unit for adjusting the voltage outputted by the power storage component to a working voltage of a load of the smartcard and outputting the adjusted working voltage to the load. The smartcard of the present invention can convert the energy outside the smartcard into electric power and store the converted electric power so as to continuously or temporarily provide power supply to the loads of the smartcard. Therefore, the cycle life of the smartcard can be extended greatly.

### FIELD OF THE INVENTION

The present invention relates to a smartcard, and in particular, a smartcard capable of utilizing regenerated electric power.

### BACKGROUND OF THE INVENTION

For a comfortable and convenient life, there are many handy and multifunctional articles designed, such as a smartcard, in which various card functions are incorporated. The smartcard is also called a chip card or an IC (Integrated Circuit) card.

The IC card can be classified into a memory card and a smartcard in light of functionality. The memory card, such as a telephone IC card for example, has the function of data storage but does not have the function of logic operation, while the smartcard, such as a smartcard with dynamic password authentication for example, has the functions of both data storage and logic operation.

The smartcard can be classified into a contact type smartcard and a contactless type smartcard in light of data transmission method. The contact type smartcard, such as a health insurance card for example, is a smartcard whose chip thereon must be put into contact with the read/write head of a card reader, which way has higher security and accuracy. The contactless type smartcard, such as an Easycard (Transportation Card for Taipei Metro Rail Transit) for example, works with the principle of RFID (Radio Frequency Identification) and has the advantages such as fast communication speed and long cycle life, but its security is slightly lower than that of the contact type smartcard. To simultaneously have the advantages of smartcard's functionality, security, accuracy, etc., the IC chips of the contact type and contactless type smartcards can be integrated in a single card.

The electric power required for a smartcard having no own power device, such as the Easycard, has to be supplied by external particular apparatus as power sources for its data storing, updating or logic operation. When a user wants to know the status of a smartcard, it is very inconvenient that the user has to operate at particular apparatus.

In view of the aforementioned problems, as disclosed by US 2009/0037928 A1, US 2010/0002025 A1, etc., a smartcard with the function of dynamic password generation was proposed, which has a built-in power device as shown by the system block diagram of a conventional smartcard in FIG. 1.

In FIG. 1, the power device 22 of the smartcard 10 supplies power to the loads of the smartcard 10 (including the dynamic password controller 12, the dynamic password generator 14, the display controller 16, the button 18 and the display 20). An unrechargeable flexible lithium battery is used as the power device 22.

When the electric power of the power device 22 of the smartcard 10 that is unrechargeable is used up, the smartcard 10 cannot be used anymore. Also, the power device 22 of unrechargeable flexible lithium battery will be affected by the temperature effect. When the environmental temperature of the smartcard 10 is lowered, the amount of electricity storage of the flexible lithium battery is reduced. As a result, the power device 22 will use up the electricity faster, making the cycle life of the smartcard 10 shorter, and the user should thus replace a new smartcard.

### SUMMARY OF THE INVENTION

The present invention provides a smartcard with regenerated electric power, which can convert the energy outside the smartcard into electric power and store the converted electric power so as to continuously or temporarily provide power supply to the loads of the smartcard. Therefore, the cycle life of the smartcard can be extended greatly.

In a first aspect, the present invention provides a smartcard, comprising:
an energy converting device for converting energy into electric power;
a power storage component for storing the electric power supplied by the energy converting device and outputting a voltage; and
a voltage stabilizing unit for adjusting the voltage outputted by the power storage component to a working voltage of a load of the smartcard and outputting the adjusted working voltage to the load.

In the smartcard according to the first aspect of the present invention, the energy converting device comprises:
an antenna for receiving a radio frequency;
a filtering and impedance matching device for filtering the radio frequency received by the antenna and performing impedance matching to generate alternating electric power; and
a rectifier for rectifying the alternating electric power generated by the filtering and impedance matching device into direct electric power and supplying the direct electric power to the electricity storage unit.

In the smartcard according to the first aspect of the present invention, the energy converting device is a solar device.

In the smartcard according to the first aspect of the present invention, the energy converting device comprises:
an oscillating/piezoelectric device for generating alternating electric power by oscillating or pressing the oscillating/piezoelectric device; and
a rectifier for rectifying the alternating electric power generated by the oscillating/piezoelectric device into direct electric power and supplying the direct electric power to the electricity storage unit.

In the smartcard according to the first aspect of the present invention, the power storage component is one of a supercapacitor and a capacitor.

The smartcard according to the first aspect of the present invention further comprises:
a battery; and
a power source selecting unit for selecting one of the battery and the voltage adjusting unit so as to supply electric power to the load.

In the smartcard according to the first aspect of the present invention, the power source selecting unit comprises:
a first diode, through which the electric power is supplied to the load from the voltage stabilizing unit; and
a second diode, through which the electric power is supplied to the load from the battery;
wherein the voltages of the positive terminals of the first and second diodes are compared, and the diode having a higher voltage is conducted.

The smartcard according to the first aspect of the present invention further comprises a rechargeable battery, wherein the voltage stabilizing unit supplies electric power to charge the rechargeable battery, and the rechargeable battery supplies electric power to the load.

In the smartcard according to the first aspect of the present invention, the voltage stabilizing unit comprises:
a switch, electrically connected to the power storage component;
a charging controlling circuit for controlling the conduction of the switch based on the power storage condition of the power storage component; and
a charging integrated circuit, electrically connected to the switch;
wherein when the switch is conducted, the charging integrated circuit controls the voltage and current outputted by the power storage component through the switch to charge the rechargeable battery.

In a second aspect, the present invention provides a smartcard, comprising:
a plurality of energy converting devices for converting energy into electric power;
a power source selecting unit for selecting the energy converting device having a higher output voltage so as to supply electric power;
a power storage component for storing the electric power supplied by the power source selecting unit and outputting a voltage; and
a voltage stabilizing unit for adjusting the voltage outputted by the power storage component to a working voltage of a load of the smartcard and outputting the adjusted working voltage to the load.

In the smartcard according to the second aspect of the present invention, the energy converting device comprises:
an antenna for receiving a radio frequency;
a filtering and impedance matching device for filtering the radio frequency received by the antenna and performing impedance matching to generate alternating electric power; and
a rectifier for rectifying the alternating electric power generated by the filtering and impedance matching device into direct electric power and supplying the direct electric power to the electricity storage unit.

In the smartcard according to the second aspect of the present invention, one of the energy converting devices is a solar device.

In the smartcard according to the second aspect of the present invention, the energy converting device comprises:
an oscillating/piezoelectric device for generating alternating electric power by oscillating or pressing the oscillating/piezoelectric device; and
a rectifier for rectifying the alternating electric power generated by the oscillating/piezoelectric device into direct electric power and supplying the direct electric power to the electricity storage unit.

In the smartcard according to the second aspect of the present invention, the power storage component is one of a supercapacitor and a capacitor.

In the smartcard according to the second aspect of the present invention, the power source selecting unit comprises:
a first diode and a second diode, through either of which the electric power is supplied to the power storage component from the plurality of energy converting devices;
wherein the voltages of the positive terminals of the first and second diodes are compared, and the diode having a higher voltage is conducted.

### BRIEF DESCRIPTION OF THE DRAWINGS

FIG. 1 is a system block diagram of a conventional smartcard.

FIG. 2 is a system block diagram of a smartcard with regenerated electric power according to a first embodiment of the present invention.

FIG. 3 is a system block diagram of a smartcard with regenerated electric power according to a second embodiment of the present invention.

FIG. 4 is a system block diagram of a smartcard with regenerated electric power according to a third embodiment of the present invention.

FIG. 5 is a system block diagram of a smartcard with regenerated electric power according to a fourth embodiment of the present invention.

FIG. 6 is a system block diagram of a smartcard with regenerated electric power according to a fifth embodiment of the present invention.

### DESCRIPTION OF PREFERRED EMBODIMENTS

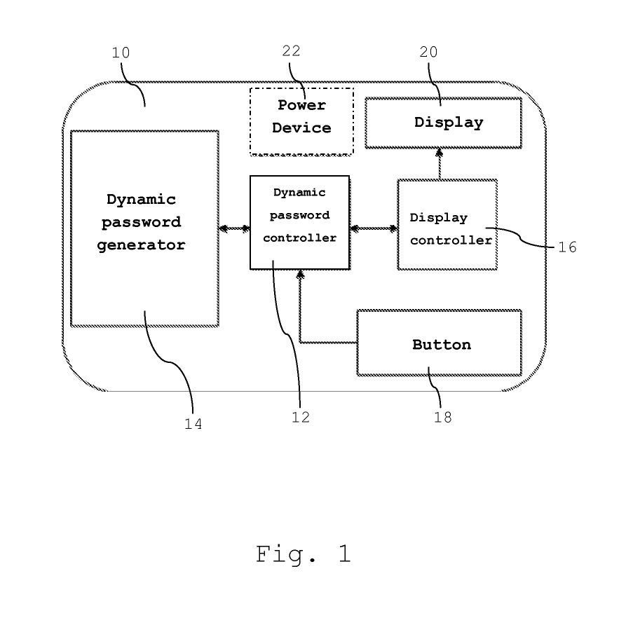

The smartcard of the present invention comprises an energy converting device, a power storage component, a voltage stabilizing unit and loads (for example, the loads in FIG. 1). The energy converting device converts energy (such as radio frequency, solar energy or oscillating/pressing forces) into electric power. The power storage component stores the electric power supplied by the energy converting device and outputs a voltage to the voltage stabilizing unit. The voltage stabilizing unit adjusts the voltage outputted by the power storage component to a working voltage of the loads of the smartcard and outputs the adjusted working voltage to the loads. Note that the power storage component is a supercapacitor or a capacitor.

The structure and technology of the smartcard with regenerated electric power according to the present invention will be described below in detail by referring to different embodiments.

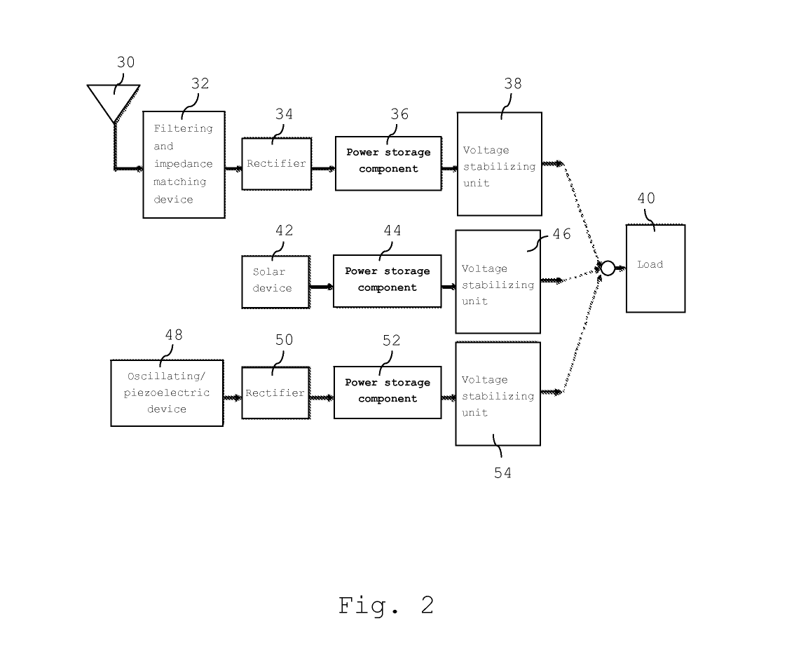

FIG. 2 is a system block diagram of a smartcard with regenerated electric power according to a first embodiment of the present invention. This embodiment is applied to the condition that the smartcard has no own battery. In FIG. 2, an antenna 30, a filtering and impedance matching device 32 and a rectifier 34 constitute a first energy converting device. The antenna 30, the filtering and impedance matching device 32, the rectifier 34, the power storage component 36 and the voltage stabilizing unit 38 constitute a first power supply path for supplying the electric power to the load 40 (for example, the loads in FIG. 1).

The antenna 30 receives a radio frequency and transmits the radio frequency to the filtering and impedance matching device 32. The filtering and impedance matching device 32 filters the radio frequency received by the antenna and performs impedance matching to generate alternating electric power, and then transmits the alternating electric power to the rectifier 34. The rectifier 34 rectifies the alternating electric power generated by the filtering and impedance matching device 32 into direct electric power and supplies the direct electric power to the power storage component 36; in other words, the rectifier 34 charges the power storage component 36. The power storage component 36 is used to store the direct electric power supplied by the rectifier 34, and the electric power stored in the power storage component 36 is released to the voltage stabilizing unit 38. The voltage stabilizing unit 38 adjusts the discharged voltage of the power storage component 36 (i.e., the electric power released by the power storage component 36) to a working voltage for the load 40 and outputs the adjusted working voltage to the load 40.

A solar device 42 is used as a second energy converting device, and a power storage component 44 is used as a power storage component. The solar device 42, the power storage component 44 and a voltage stabilizing unit 46 constitute a second power supply path for supplying the electric power to the load 40.

The solar device 42 receives the solar light to generate direct electric power and supplies the direct electric power to the power storage component 44; in other words, the solar device 42 charges the power storage component 44. The power storage component 44 is used to store the direct electric power supplied by the solar device 42, and the electric power stored in the power storage component 44 is released to the voltage stabilizing unit 46. The voltage stabilizing unit 46 adjusts the discharged voltage of the power storage component 44 (i.e., the electric power released by the power storage component 44) to a working voltage for the load 40 and outputs the adjusted working voltage to the load 40.

An oscillating/piezoelectric device 48 and a rectifier 50 constitute a third energy converting device, and a power storage component 52 is used as a power storage component. The oscillating/piezoelectric device 44, the rectifier 50, the power storage component 52 and a voltage stabilizing unit 54 constitute a third power supply path for supplying the electric power to the load 40.

The oscillating/piezoelectric device 48 generates alternating electric power by oscillating or pressing the oscillating/piezoelectric device 48, and supplies the alternating electric power to the rectifier 50. The rectifier 50 rectifies the alternating electric power generated by the oscillating/piezoelectric device 48 into direct electric power and supplies the direct electric power to the power storage component 52; in other words, the rectifier 50 charges the power storage component 52. The power storage component 52 is used to store the direct electric power supplied by the rectifier 50, and the electric power stored in the power storage component 52 is released to the voltage stabilizing unit 54. The voltage stabilizing unit 54 adjusts the discharged voltage of the power storage component 52 (i.e., the electric power released by the power storage component 52) to a working voltage for the load 40 and outputs the adjusted working voltage to the load 40.

In this embodiment, the smartcard with regenerated electric power can supply electric power to the load 40 of the smartcard via the circuit configurations of the three power supply paths for supplying electric power to the load 40, or can supply electric power to the load 40 of the smartcard via the circuit configurations of either one or either two power supply paths. After the load 40 of the smartcard obtains the regenerated electric power (the electric power converted from such as radio frequency, solar energy or oscillation), the smartcard can operate in accordance with the functionality designed therefor.

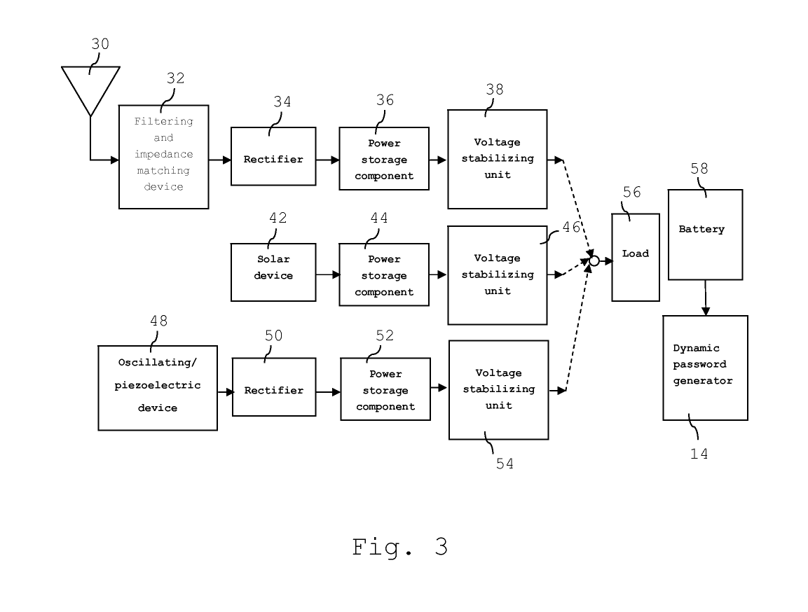

FIG. 3 is a system block diagram of a smartcard with regenerated electric power according to a second embodiment of the present invention. This embodiment is applied to the condition that the smartcard has its own battery and the battery is an unrechargeable battery. The reference numerals in FIG. 3 that are the same as those in FIG. 2 represent the same components, and the description thereof are thus omitted. The difference between the circuit configurations of FIG. 3 and FIG. 2 is that a battery 58 is added in FIG. 3, and the load 56 and the dynamic password generator 14 in FIG. 3 constitute the load 40 in FIG. 2.

In the second embodiment, the battery 58 of the smartcard supplies electric power to the dynamic password generator 14 of the smartcard in FIG. 1, and supplies electric power to other loads of the smartcard in FIG. 1 (i.e. the load 56 of the second embodiment) via the circuit configuration of the three power supply paths of the first embodiment. The way that the circuit configurations of the three power supply paths supply electric power to the load 56 is the same as that of the first embodiment, and the description thereof is thus omitted.

Compared with the circuit configuration of the first embodiment, the battery of the second embodiment supplies electric power only to the dynamic password generator 14, and the circuit configurations of the three power supply paths of the second embodiment supply electric power to the load 56 of the smartcard, such that the second embodiment can extend the time that the battery 58 supplies electric power; namely, the life cycle of the smartcard is extended.

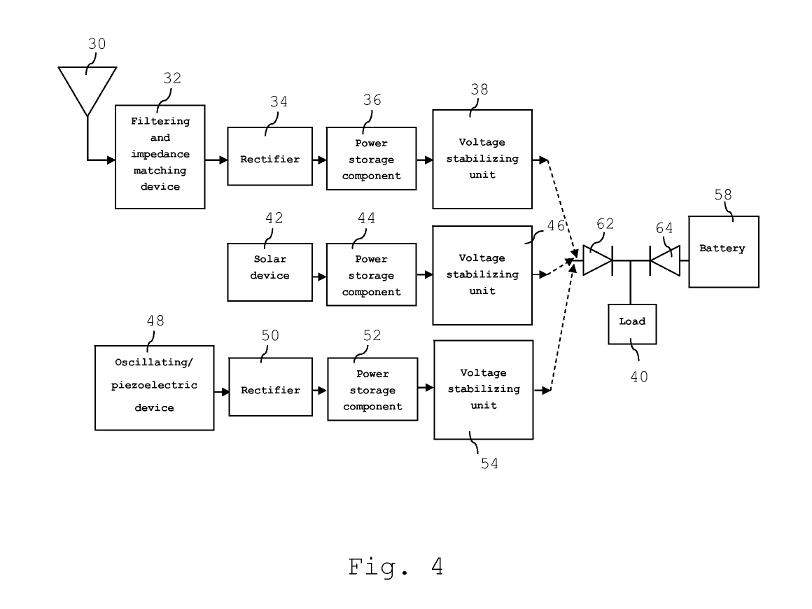

FIG. 4 is a system block diagram of a smartcard with regenerated electric power according to a third embodiment of the present invention. This embodiment is applied to the condition that the smartcard has its own battery and the battery is an unrechargeable battery. The reference numerals in FIG. 4 that are the same as those in FIG. 2 represent the same components, and the description thereof are thus omitted. The difference between the circuit configurations of FIG. 4 and FIG. 2 is that a battery 58 and diodes 62 and 64 constituting a power source selecting unit are added in FIG. 4. The power source selecting unit selects the battery 58 or the voltage adjusting units 38, 46 and 54 to supply electric power to the load 40.

In the third embodiment, the positive terminal of the diode 62 is electrically connected to the voltage stabilizing output terminals of the voltage stabilizing units 38, 46 and 54, the positive terminal of the diode 64 is electrically connected to the power supply terminal of the battery 58, and both the negative terminals of the diodes 62 and 64 are electrically connected to the load 40. The voltage stabilizing units 38, 46 and 54 supply electric power to the load 40 through the diode 62, and the battery 58 supplies electric power to the load 40 through the diode 64.

The voltages of the positive terminals of the diode 62 and the diode 64 are compared. If the voltage of the positive terminal of the diode 62 is higher than the voltage of the positive terminal of the diode 64, the diode 62 is conducted; namely, the electric power is supplied to the load 40 by the voltage stabilizing units 38, 46 and 54. If the voltage of the positive terminal of the diode 64 is higher than the voltage of the positive terminal of the diode 62, the diode 64 is conducted; namely, the electric power is supplied to the load 40 by the battery 58. After the load 40 of the smartcard obtains the regenerated electric power (the electric power converted from such as radio frequency, solar energy or oscillation) or the built-in electric power (i.e. the battery 58), the smartcard can operate in accordance with the functionality designed therefor.

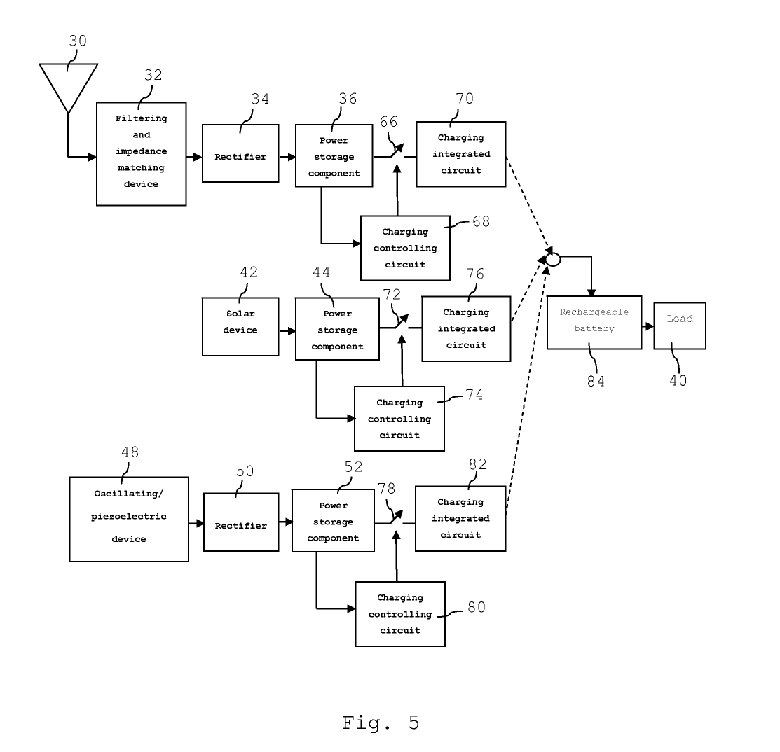

FIG. 5 is a system block diagram of a smartcard with regenerated electric power according to a fourth embodiment of the present invention. This embodiment is applied to the condition that the smartcard has its own battery and the battery is a rechargeable battery. The reference numerals in FIG. 5 that are the same as those in FIG. 2 represent the same components, and the description thereof are thus omitted. The difference between the circuit configurations of FIG. 5 and FIG. 2 is that a rechargeable battery 84 is added between the voltage stabilizing unit and the load 40 in FIG. 5, and the voltage stabilizing unit comprises a switch, a charging controlling circuit and a charging integrated circuit.

In FIG. 5, a first voltage stabilizing unit comprises a switch 66, a charging controlling circuit 68 and a charging integrated circuit 70, a second voltage stabilizing unit comprises a switch 72, a charging controlling circuit 74 and a charging integrated circuit 76, and a third voltage stabilizing unit comprises a switch 78, a charging controlling circuit 80 and a charging integrated circuit 82.

The antenna 30, the filtering and impedance matching device 32, the rectifier 34, the power storage component 36, the switch 66, the charging controlling circuit 68 and the charging integrated circuit 70 constitute a first power supply path for charging the rechargeable battery 84. The solar device 42, the power storage component 44, the switch 72, the charging controlling circuit 74 and the charging integrated circuit 76 constitute a second power supply path for charging the rechargeable battery 84. The oscillating/piezoelectric device 48, the rectifier 50, the power storage component 52, the switch 78, the charging controlling circuit 80 and the charging integrated circuit 82 constitute a third power supply path for charging the rechargeable battery 84.

In the fourth embodiment, the smartcard with regenerated electric power can charge the rechargeable battery 84 via the circuit configurations of the three power supply paths for charging the rechargeable battery 84, or can charge the rechargeable battery 84 via the circuit configurations of either one or either two power supply paths. After the rechargeable battery 84 obtains the regenerated electric power (the electric power converted from such as radio frequency, solar energy or oscillation) and is charged, the rechargeable battery 84 can supplies electric power to the load 40 of the smartcard so that the smartcard can operate in accordance with the functionality designed therefor.

The switch 66 is electrically connected to the power storage component 36, and when the switch 66 is conducted, the electric power stored in the power storage component 36 is transmitted to the charging integrated circuit 70 through the switch 66. The charging controlling circuit 68 is used to control the conduction and breaking of the switch 66. When the charging controlling circuit 68 judges that the discharged voltage of the power storage component 36 reaches a voltage capable of charging the rechargeable battery 84, the charging controlling circuit 68 controls the switch 66 to be conducted; otherwise, the charging controlling circuit 68 controls the switch 66 to break. The charging integrated circuit 70 is electrically connected to the switch 66, and when the switch 66 is conducted, the charging integrated circuit 70 controls the magnitude of the voltage and current outputted by the power storage component 36 to charge the rechargeable battery 84.

Similarly, the switch 72 is electrically connected to the power storage component 44, and when the switch 72 is conducted, the electric power stored in the power storage component 44 is transmitted to the charging integrated circuit 76 through the switch 72. The charging controlling circuit 74 is used to control the conduction and breaking of the switch 72. When the charging controlling circuit 74 judges that the discharged voltage of the power storage component 44 reaches a voltage capable of charging the rechargeable battery 84, the charging controlling circuit 74 controls the switch 72 to be conducted; otherwise, the charging controlling circuit 74 controls the switch 72 to break. The charging integrated circuit 76 is electrically connected to the switch 72, and when the switch 72 is conducted, the charging integrated circuit 76 controls the magnitude of the voltage and current outputted by the power storage component 44 to charge the rechargeable battery 84.

The switch 78 is electrically connected to the power storage component 52, and when the switch 78 is conducted, the electric power stored in the power storage component 52 is transmitted to the charging integrated circuit 82 through the switch 78. The charging controlling circuit 80 is used to control the conduction and breaking of the switch 78. When the charging controlling circuit 80 judges that the discharged voltage of the power storage component 52 reaches a voltage capable of charging the rechargeable battery 84, the charging controlling circuit 80 controls the switch 78 to be conducted; otherwise, the charging controlling circuit 80 controls the switch 78 to break. The charging integrated circuit 82 is electrically connected to the switch 78, and when the switch 78 is conducted, the charging integrated circuit 82 controls the magnitude of the voltage and current outputted by the power storage component 52 to charge the rechargeable battery 84.

In the fourth embodiment, the rechargeable battery 84 can be charged at any time by the regenerated electric power (the electric power converted from such as radio frequency, solar energy or oscillation) so as to continuously supply electric power to the load 40 of the smartcard, and can avoid the problem that the load 40 of the smartcard exhausts the electric power of the rechargeable battery 84.

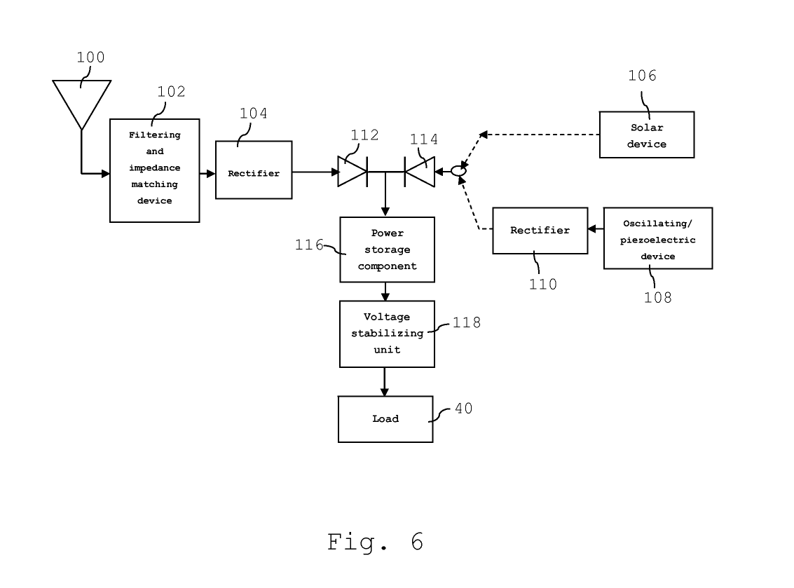

FIG. 6 is a system block diagram of a smartcard with regenerated electric power according to a fifth embodiment of the present invention. This embodiment is applied to the condition that the smartcard has no own battery. In FIG. 6, an antenna 100, a filtering and impedance matching device 102 and a rectifier 104 constitute a first energy converting device, a solar device 106 is used as a second energy converting device, and an oscillating/piezoelectric device 108 and a rectifier 110 constitute a third energy converting device.

Diodes 112 and 114 constitute a power source selecting unit. The positive terminal of the diode 112 is electrically connected to the output terminal of the rectifier 104, the positive terminal of the diode 114 is electrically connected to the power supply terminal of the solar device 106 and the output terminal of the rectifier 110, and both the negative terminals of the diode 112 and the diode 114 are electrically connected to the power storage component 116. The direct electric power rectified by the rectifier 104 charges the power storage component 116 through the diode 62, and the direct electric power generated by the solar device 106 and the direct electric power rectified by the rectifier 110 charge the power storage component 116 through the diode 114.

The voltages of the positive terminals of the diode 112 and the diode 114 are compared. If the voltage of the positive terminal of the diode 112 is higher than the voltage of the positive terminal of the diode 114, the diode 112 is conducted; namely, the power storage component 116 is charged by the direct electric power rectified by the rectifier 104. If the voltage of the positive terminal of the diode 114 is higher than the voltage of the positive terminal of the diode 112, the diode 114 is conducted; namely, the power storage component 116 is charged by the direct electric power generated by the solar device 106 and the direct electric power rectified by the rectifier 110. In another embodiment, the positive terminal of the diode 114 can be electrically connected solely to the second energy converting device (i.e. the solar device 106) or the third energy converting device (the rectifier 110 thereof).

The power storage component 116 is used to store the direct electric power rectified by the rectifier 104, or the direct electric power generated by the solar device 106 and the direct electric power rectified by the rectifier 110. The electric power stored in the power storage component 116 is released to a voltage stabilizing unit 118 (namely, the power storage component 116 is charged). The voltage stabilizing unit 118 adjusts the discharged voltage of the power storage component 116 (namely, the power storage component 116 is discharged) to a working voltage of the load 40, and outputs the adjusted working voltage to the load 40 (for example, the loads in FIG. 1). After the load 40 of the smartcard obtains the regenerated electric power (the electric power converted from such as radio frequency, solar energy or oscillation), the smartcard can operate in accordance with the functionality designed therefor.

In the fifth embodiment, for the smartcard in which the loads do not need continuous power supply, when the load of the smartcard needs electric power, the power storage component 116 can be charged at any time by the regenerated electric power (the electric power converted from such as radio frequency, solar energy or oscillation), and the charged power storage component 116 can supply the required electric power to the load 40 of the smartcard through the voltage stabilizing unit 118.

The present invention is advantageous in providing a smartcard with regenerated electric power, and the circuit configuration of the smartcard with built-in regenerated electric power can convert the energy outside the smartcard into electric power and store the converted electric power so as to continuously or temporarily provide power supply to the loads of the smartcard. Therefore, the cycle life of the smartcard can be extended greatly.

While the present invention has been described above with reference to the preferred embodiment and illustrative drawings, it should not be considered as limited thereby. Various equivalent alterations, omissions and modifications made to its configuration and the embodiments by the skilled persons could be conceived of without departing from the scope of the present invention.

### REFERENCE NUMERALS

10 smartcard
12 dynamic password controller
14 dynamic password generator
16 display controller
18 button
20 display
22 power device
30 antenna
32 filtering and impedance matching device
34 rectifier
36 power storage component
38 voltage stabilizing unit
40 load
42 solar device
44 power storage component
46 stabilizing unit
48 oscillating/piezoelectric device
50 rectifier
52 power storage component
54 voltage stabilizing unit
56 load
58 battery
62 diode
64 diode
66 switch
68 charging controlling circuit
70 charging integrated circuit
72 switch
74 charging controlling circuit
76 charging integrated circuit
78 switch
80 charging controlling circuit
82 charging integrated circuit
84 rechargeable battery
100 antenna
102 filtering and impedance matching device
104 rectifier
106 solar device
108 oscillating/piezoelectric device
110 rectifier
112 diode
114 diode
116 power storage component
118 voltage stabilizing unit

What is claimed is:

1. A smartcard, comprising:
an energy converting device for converting energy into electric power;
a power storage component for storing the electric power supplied by the energy converting device and outputting a voltage; and
a voltage stabilizing unit for adjusting the voltage outputted by the power storage component to a working voltage of a load of the smartcard and outputting the adjusted working voltage to the load.

2. The smartcard according to claim 1, wherein the energy converting device comprises:
an antenna for receiving a radio frequency;
a filtering and impedance matching device for filtering the radio frequency received by the antenna and performing impedance matching to generate alternating electric power; and
a rectifier for rectifying the alternating electric power generated by the filtering and impedance matching device into direct electric power and supplying the direct electric power to the electricity storage unit.

3. The smartcard according to claim 1, wherein the energy converting device is a solar device.

4. The smartcard according to claim 1, wherein the energy converting device comprises:
an oscillating/piezoelectric device for generating alternating electric power by oscillating or pressing the oscillating/piezoelectric device; and
a rectifier for rectifying the alternating electric power generated by the oscillating/piezoelectric device into direct electric power and supplying the direct electric power to the electricity storage unit.

5. The smartcard according to claim 1, wherein the power storage component is one of a supercapacitor and a capacitor.

6. The smartcard according to claim 1, further comprising:
a battery; and
a power source selecting unit for selecting one of the battery and the voltage adjusting unit so as to supply electric power to the load.

7. The smartcard according to claim 6, wherein the power source selecting unit comprises:
a first diode, through which the electric power is supplied to the load from the voltage stabilizing unit; and
a second diode, through which the electric power is supplied to the load from the battery;
wherein the voltages of the positive terminals of the first and second diodes are compared, and the diode having a higher voltage is conducted.

8. The smartcard according to claim 1, further comprising a rechargeable battery, wherein the voltage stabilizing unit supplies electric power to charge the rechargeable battery, and the rechargeable battery supplies electric power to the load.

9. The smartcard according to claim 8, wherein the voltage stabilizing unit comprises:
a switch, electrically connected to the power storage component;
a charging controlling circuit for controlling the conduction of the switch based on the power storage condition of the power storage component; and
a charging integrated circuit, electrically connected to the switch;
wherein when the switch is conducted, the charging integrated circuit controls the voltage and current outputted by the power storage component through the switch to charge the rechargeable battery.

10. A smartcard, comprising:
a plurality of energy converting devices for converting energy into electric power;
a power source selecting unit for selecting the energy converting device having a higher output voltage so as to supply electric power;
a power storage component for storing the electric power supplied by the power source selecting unit and outputting a voltage; and
a voltage stabilizing unit for adjusting the voltage outputted by the power storage component to a working voltage of a load of the smartcard and outputting the adjusted working voltage to the load.

11. The smartcard according to claim 10, wherein the energy converting device comprises:
an antenna for receiving a radio frequency;
a filtering and impedance matching device for filtering the radio frequency received by the antenna and performing impedance matching to generate alternating electric power; and
a rectifier for rectifying the alternating electric power generated by the filtering and impedance matching device into direct electric power and supplying the direct electric power to the electricity storage unit.

12. The smartcard according to claim 10, wherein one of the energy converting devices is a solar device.

13. The smartcard according to claim 10, wherein the energy converting device comprises:
an oscillating/piezoelectric device for generating alternating electric power by oscillating or pressing the oscillating/piezoelectric device; and
a rectifier for rectifying the alternating electric power generated by the oscillating/piezoelectric device into direct electric power and supplying the direct electric power to the electricity storage unit.

14. The smartcard according to claim 10, wherein the power storage component is one of a supercapacitor and a capacitor.

15. The smartcard according to claim 10, wherein the power source selecting unit comprises:
a first diode and a second diode, through either of which the electric power is supplied to the power storage component from the plurality of energy converting devices;
wherein the voltages of the positive terminals of the first and second diodes are compared, and the diode having a higher voltage is conducted.
